(19) United States
(12) Patent Application Publication
(10) Pub. No.: US 2025/0324183 A1
(43) Pub. Date: Oct. 16, 2025

(54) WIRELESS MICROPHONE AND CONTROL METHOD

(71) Applicant: CANON KABUSHIKI KAISHA, Tokyo (JP)

(72) Inventors: TOMOKUNI HIROSAWA, Kanagawa (JP); KUNIHISA NAKAO, Kanagawa (JP)

(21) Appl. No.: 19/250,279

(22) Filed: Jun. 26, 2025

Related U.S. Application Data
(63) Continuation of application No. PCT/JP2023/040026, filed on Nov. 7, 2023.

(30) Foreign Application Priority Data
Dec. 27, 2022 (JP) 2022-210204

(51) Int. Cl. H04R 1/08; G06F 3/16; H04N 9/802

(52) U.S. Cl. CPC H04R 1/08; G06F 3/16; H04N 9/802; H04R 2420/07

(57) ABSTRACT

A wireless microphone capable of communicating with an image capture apparatus, generates audio data, transmits, as audio data for a moving image file generated by the image capture apparatus, the audio data to the image capture apparatus, records the audio data as an audio file, and receives information including time information from the image capture apparatus, and adds, to the audio file, time stamp information generated based on the time information received from the image capture apparatus, transmission of the audio data to the image capture apparatus and recording of the audio data by the recording unit are executed simultaneously.

### CROSS-REFERENCE TO RELATED APPLICATIONS

This application is a Continuation of International Patent Application No. PCT/JP2023/040026, filed Nov. 7, 2023, which claims the benefit of Japanese Patent Application No. 2022-210204, filed Dec. 27, 2022, both of which are hereby incorporated by reference herein in their entirety.

### BACKGROUND

### Field of the Technology

The present disclosure relates to a technique for associating an audio file recorded by a wireless microphone and an image file recorded by an image capture apparatus with each other.

### Description of the Related Art

PTL 1 describes a technique for associating an audio file and an image file recorded by an image capture apparatus with each other by setting the same file name for these files.

### CITATION LIST

### Patent Literature

PTL 1: Japanese Patent Laid-Open No. 2002-223401

However, in PTL 1, associating an audio file and an image file recorded in different apparatuses with each other, as in a case where an audio file is recorded by a wireless microphone and an image file is recorded by an image capture apparatus, is not assumed.

### SUMMARY

The present disclosure has been made in consideration of the above-described problem, and implements a technique capable of associating an audio file and an image file recorded in different apparatuses with each other.

The present disclosure is directed to a wireless microphone capable of communicating with an image capture apparatus, comprising:
a generation unit configured to generate audio data;
a transmission unit configured to transmit, as audio data for a moving image file generated by the image capture apparatus, the audio data to the image capture apparatus;
a recording unit configured to record the audio data as an audio file; and
a control unit configured to receive information including time information from the image capture apparatus, and add, to the audio file, time stamp information generated based on the time information received from the image capture apparatus,
wherein transmission of the audio data to the image capture apparatus by the transmission unit and recording of the audio data by the recording unit are executed simultaneously.

The present disclosure is directed to a wireless microphone capable of communicating with an image capture apparatus, comprising:
a connection unit configured to detachably connect to a memory card;
a generation unit configured to generate audio data;
a transmission unit configured to transmit, as audio data for a moving image file generated by the image capture apparatus, the audio data to the image capture apparatus;
a recording unit configured to record the audio data as an audio file in the memory card; and
a control unit configured to receive information from the image capture apparatus, and add, to the audio file, additional information generated based on the information received from the image capture apparatus.

The present disclosure is directed to a control method for a wireless microphone capable of communicating with an image capture apparatus, comprising:
generating audio data;
transmitting, as audio data for a moving image file generated by the image capture apparatus, the audio data to the image capture apparatus;
recording the audio data as an audio file; and
receiving information including time information from the image capture apparatus, and adding, to the audio file, time stamp information generated based on the time information received from the image capture apparatus,
wherein transmission of the audio data to the image capture apparatus and recording of the audio data are executed simultaneously.

The present disclosure is directed to a control method for a wireless microphone capable of communicating with an image capture apparatus, comprising:
detachably connecting to a memory card;
generating audio data;
transmitting, as audio data for a moving image file generated by the image capture apparatus, the audio data to the image capture apparatus;
recording the audio data as an audio file in the memory card; and
receiving information from the image capture apparatus, and adding, to the audio file, additional information generated based on the information received from the image capture apparatus.

Features of the present disclosure will become apparent from the following description of embodiments with reference to the attached drawings.

### BRIEF DESCRIPTION OF THE DRAWINGS

FIG. 1 is a block diagram showing the configurations of an audio recording apparatus, a communication apparatus, and an image capture apparatus forming a system according to a present embodiment.

FIG. 2 is a flowchart illustrating the operation of the audio recording apparatus according to the present embodiment.

FIG. 3 is a flowchart illustrating the operation of the communication apparatus according to the present embodiment.

FIG. 4 is a flowchart illustrating the operation of the image capture apparatus according to the present embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### <System Configuration>

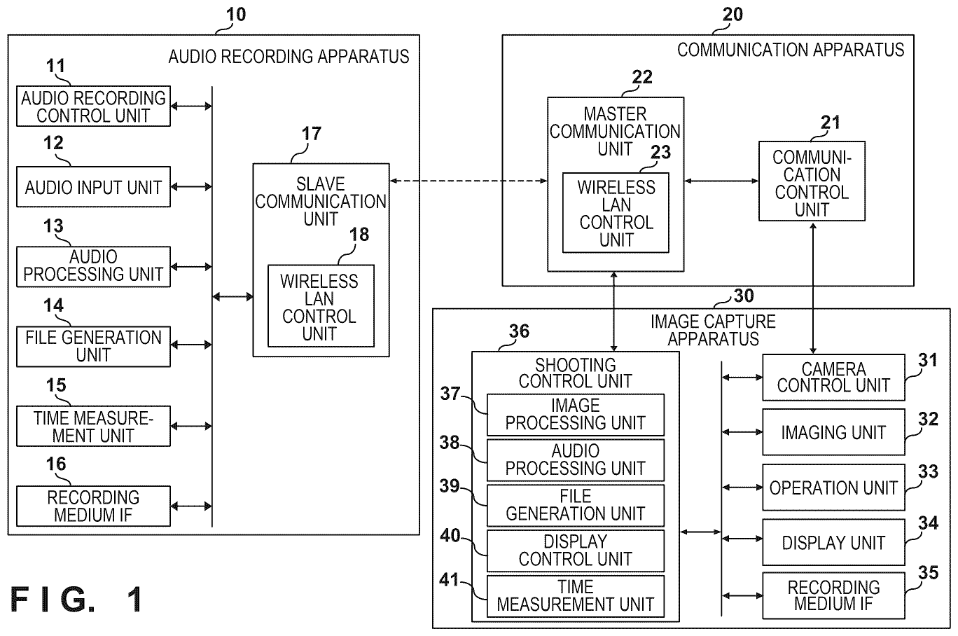

A system according to the present embodiment will be described with reference to FIG. 1.

The system according to the present embodiment includes an audio recording apparatus 10, a communication apparatus 20, and an image capture apparatus 30. The audio recording apparatus 10 and the image capture apparatus 30 are wirelessly and communicatively connected via a network formed by the communication apparatus 20. The communication apparatus 20 functions as a master that forms an access point of a wireless LAN (Local Area Network) complying with the IEEE 802.11 communication standard. Each of the audio recording apparatus 10 and the image capture apparatus 30 functions as a slave that is connected to a network formed by the image capture apparatus 30 via the access point of the wireless LAN. The audio recording apparatus 10 and the image capture apparatus 30 are wirelessly and communicatively connected via the communication apparatus 20.

The communication apparatus 20 is network equipment such as a router that operates as the access point of the wireless LAN. The audio recording apparatus 10 is acoustic equipment such as a wireless microphone having a function of recording an audio. The image capture apparatus 30 is visual equipment such as a digital camera that shoots and records a still image and a moving image.

The system according to the present embodiment performs audio recording by the audio recording apparatus 10 wirelessly connected to the image capture apparatus 30 during moving image recording and audio recording by the image capture apparatus 30. An audio file recorded by the audio recording apparatus 10 is stored, in the audio recording apparatus 10, as a backup file of a moving image file recorded by the image capture apparatus 30. In the present embodiment, it is possible wo associate the audio file recorded by the audio recording apparatus 10 with the moving image file recorded by the image capture apparatus 30.

According to the present embodiment, for example, in a case where a plurality of audio recording apparatuses 10 and the image capture apparatus 30 are wirelessly connected, it is possible to improve a situation in which the relationship between an audio file recorded by each audio recording apparatus 10 and a moving image file recorded by the image capture apparatus 30 cannot be recognized. This can reduce the cumbersomeness of an operation of, for example, finding an audio file corresponding to a moving image file to edit the moving image file.

Note that the present embodiment will describe an example in which the audio recording apparatus 10 connected to the image capture apparatus 30 by the wireless LAN performs audio recording during moving image recording and audio recording by the image capture apparatus 30. However, the present disclosure is not limited to moving image recording, and still image shooting (for example, continuous shooting or time lapse shooting) may be performed.

### <Apparatus Configuration>

The configurations and functions of the audio recording apparatus 10, the communication apparatus 20, and the image capture apparatus 30 forming the system according to the present embodiment will be described next with reference to FIG. 1.

The configuration and function of the audio recording apparatus 10 will be described first.

The audio recording apparatus 10 includes an audio recording control unit 11, an audio input unit 12, an audio processing unit 13, a file generation unit 14, a time measurement unit 15, a recording medium interface (IF) 16, and a slave communication unit 17.

Note that each component of the audio recording apparatus 10 includes a processor, a controller, and a peripheral circuit which are necessary to implement each function to be described later.

The audio recording control unit 11 includes a processor (MPU) that performs arithmetic processing and control processing of the audio recording apparatus 10, a volatile memory (ROM) that stores a program to be executed by the processor, and a work memory (RAM) into which a program read out from a nonvolatile memory, constants and variables for executing the program, and the like are loaded. The audio recording control unit 11 controls each component (to be described later) of the audio recording apparatus 10 by loading the program stored in the ROM into the RAM and executing it.

The audio input unit 12 includes one or a plurality of microphones incorporated in the audio recording apparatus 10 or connected via audio terminals, and converts, into a digital signal, an analog audio signal generated by collecting an audio around the audio recording apparatus 10, and outputs the digital signal to the audio processing unit 13.

The audio processing unit 13 performs various kinds of audio processes for the digital audio signal generated by the audio input unit 12, thereby generating audio data.

The file generation unit 14 generates an audio file in a predetermined format from the audio data generated by the audio processing unit 13. The predetermined format is, for example, MP3 or WAV The file generation unit 14 generates time stamp information based on time information and moving image recording start information received from the image capture apparatus 30, and adds the time stamp information to the audio file. The file generation unit 14 writes the audio file added with the time stamp information in a recording medium (not shown) via the recording medium IF 16. This can record the audio file recorded by the audio recording apparatus 10 during moving image recording of the image capture apparatus 30 in association with the moving image file recorded by the image capture apparatus 30. Note that in the present embodiment, the time information includes a date, a time, and a time zone. The time stamp information is data indicating time information at the time of generating the time stamp information.

The time measurement unit 15 includes a circuit such as a real time clock that measures the time to generate the current time and date. The time measurement unit 15 sets, as a reference time, the time information received from the image capture apparatus 30, measures the time based on the reference time, and updates the time information in real time.

The recording medium IF 16 can be connected to a recording medium such as a memory card or a hard disk to make it possible to write an audio file in the recording medium and read out an audio file from the recording medium.

The slave communication unit 17 includes a wireless LAN control unit 18 that performs communication processing for causing the audio recording apparatus 10 to operate as a slave of the wireless LAN.

The wireless LAN control unit 18 controls connection or disconnection to or from the wireless LAN via an access point formed by a master communication unit 22 of the communication apparatus 20. The wireless LAN control unit 18 can transmit/receive various kinds of data including the audio data to/from the master communication unit 22 of the communication apparatus 20 by a predetermined communication method. The predetermined communication method is not limited to the wireless LAN, and may be Bluetooth (Registered trademark), Wireless USB, ZigBee (Registered trademark), or the like.

The configuration and function of the communication apparatus 20 will be described next.

The communication apparatus 20 includes a communication control unit 21 and the master communication unit 22.

Note that each component of the communication apparatus 20 includes a processor, a controller, and a peripheral circuit which are necessary to implement each function to be described later.

The communication control unit 21 includes a processor (MPU) that performs arithmetic processing and control processing of the communication apparatus 20, a volatile memory (ROM) that stores a program to be executed by the processor, and a work memory (RAM) into which a program read out from a nonvolatile memory, constants and variables for executing the program, and the like are loaded. The communication control unit 21 controls the master communication unit 22 by loading the program stored in the ROM into the RAM and executing it.

The master communication unit 22 includes a wireless LAN control unit 23 that performs communication processing for causing the communication apparatus 20 to operate as a master of the wireless LAN.

The wireless LAN control unit 23 controls connection or disconnection of the audio recording apparatus 10 as the slave to or from the wireless LAN via the access point of the wireless LAN that is formed by the master communication unit 22. The wireless LAN control unit 23 can transmit/receive various kinds of data including the audio data to/from the slave communication unit 17 of the audio recording apparatus 10 by a predetermined communication method. The predetermined communication method is not limited to the wireless LAN, and may be Bluetooth (Registered trademark), Wireless USB, ZigBee (Registered trademark), or the like.

Note that in the present embodiment, the communication apparatus 20 is connected to the image capture apparatus 30 by a wire such as a cable or a connector, the communication control unit 21 is connected to a camera control unit 31 of the image capture apparatus 30 to be able to exchange data, and the master communication unit 22 is connected to a shooting control unit 36 of the image capture apparatus 30 to be able to exchange data. As the communication method between the communication control unit 21 and the camera control unit 31 and that between the master communication unit 22 and the shooting control unit 36, SPI, I2C, or the like is used.

Note that the communication apparatus 20 is not limited to the configuration in which the communication apparatus 20 is connected to the image capture apparatus 30 by a wire, and the communication apparatus 20 may be incorporated in the image capture apparatus 30 or may wirelessly be connected to the image capture apparatus 30.

The present embodiment has exemplified the form (infrastructure mode) in which the audio recording apparatus 10 and the image capture apparatus 30 communicate with each other by using the communication apparatus 20 as an access point. However, a form (ad hoc mode) in which the audio recording apparatus 10 and the image capture apparatus 30 directly communicate with each other may be adopted. The communication apparatus 20 may or may not be configured to have a gateway function of transferring data received from the audio recording apparatus 10 or the image capture apparatus 30 to an external apparatus via a wide area network such as the Internet.

The configuration and function of the image capture apparatus 30 will be described next.

The image capture apparatus 30 includes the camera control unit 31, an imaging unit 32, an operation unit 33, a display unit 34, and a recording medium interface 35.

Note that each component of the image capture apparatus 30 includes a processor, a controller, and a peripheral circuit which are necessary to implement each function to be described later.

The camera control unit 31 includes a processor (MPU) that performs arithmetic processing and control processing of the image capture apparatus 30, a volatile memory (ROM) that stores a program to be executed by the processor, and a work memory (RAM) into which a program read out from a nonvolatile memory, constants and variables for executing the program, and the like are loaded. The camera control unit 31 controls each component (to be described later) of the image capture apparatus 30 by loading the program stored in the ROM into the RAM and executing it.

The imaging unit 32 includes a lens group including a zoom lens and a focus lens, and a shutter having an aperture function. Furthermore, the imaging unit 32 includes an image sensor formed by a CCD or CMOS sensor that converts an object image into an electrical signal, and an A/D converter that converts an analog image signal output from the image sensor into a digital signal. Under the control of the camera control unit 31, the imaging unit 32 converts object image light whose image is formed by the lenses included in the imaging unit 32 into an electrical signal by the image sensor, performs noise reduction processing or the like, and outputs image data formed by a digital signal.

The operation unit 33 is formed by operation members such as various kinds of switches, buttons, and dials for accepting various kinds of operations from the user. The operation unit 33 also includes a touch panel integrated with the display unit 34 to be described later.

The display unit 34 displays a live view image, a shot image, characters for interactive operations, and the like. The display unit 34 is, for example, a display device such as a liquid crystal display or an organic EL display. The display unit 34 may be integrated with the image capture apparatus 30 or may be an external apparatus connected to the image capture apparatus 30.

The recording medium IF 35 can be connected to a recording medium such as a memory card or a hard disk to make it possible to write a still image file, a moving image file, and an audio file in the recording medium and read out a still image file, a moving image file, and an audio file from the recording medium.

The shooting control unit 36 includes an image processing unit 37, an audio processing unit 38, a file generation unit 39, a display control unit 40, and a time measurement unit 41. Note that each component of the shooting control unit 36 includes a processor, a controller, and a peripheral circuit which are necessary to implement each function to be described later.

The image processing unit 37 performs resize processing such as pixel interpolation and reduction or color conversion processing for image data captured by the imaging unit 32. The camera control unit 31 performs predetermined arithmetic processing using the image data captured by the imaging unit 32, and controls the focus lens, the aperture, and the shutter of the imaging unit 32 based on the arithmetic result, thereby performing AF (Auto Focus) processing or AE (Auto Exposure) processing.

The audio processing unit 38 performs various kinds of audio processes for a digital audio signal generated by an audio input unit (not shown) of the image capture apparatus 30, thereby generating audio data. Furthermore, the audio processing unit 38 performs various kinds of audio processes for a digital audio signal received from the audio recording apparatus 10 via the communication apparatus 20, thereby generating audio data.

The file generation unit 39 generates a still image file by performing compression coding using the JPEG format or the like for still image data that has undergone image processing by the image processing unit 37, and generates a moving image file by encoding moving image data by a moving image compression method such as MPEG2 or H.264, thereby writing the files in the recording medium via the recording medium IF 35. Furthermore, the file generation unit 39 generates an audio file in a predetermined format based on the audio data generated by the audio processing unit 38 or the audio data received from the audio recording apparatus 10, thereby writing the audio file in the recording medium via the recording medium IF 35. The file generation unit 39 reads out, via the recording medium IF 35, the still image file, moving image file, and audio file recorded in the recording medium.

The display control unit 40 generates display data such as the live view image captured by the imaging unit 32, the still image data or moving image data read out from the recording medium, or a GUI (Graphical User Interface), and displays the display data on the display unit 34.

The time measurement unit 41 includes a circuit such as a real time clock that measures the time to generate the current time and date. The time measurement unit 41 sets, as a reference time, time information set by a user operation, measures the time based on the reference time, and updates the time information in real time. The camera control unit 31 displays, on the display unit 34, a time setting screen for prompting the user to perform time setting. The user inputs time information (date, time, and time zone) to the time setting screen by operating the operation unit 33. The camera control unit 31 outputs, to the time measurement unit 41, the time information input to the time setting screen. The time measurement unit 41 sets, as the current time information, the time information input to the time setting screen, and measures the time by using the set time information as the reference time.

### <Control Processing>

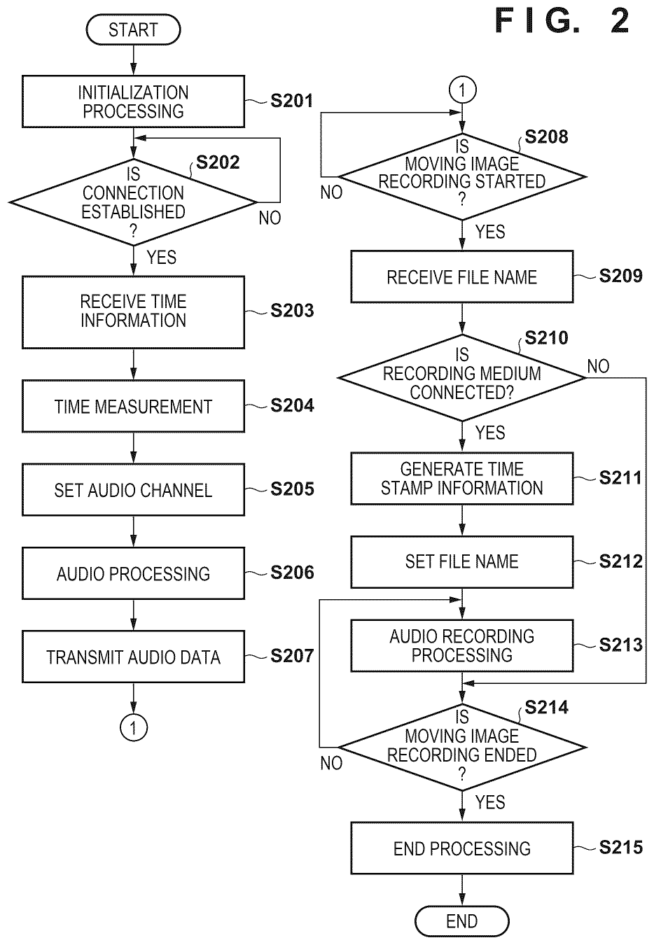

The control processing of the audio recording apparatus 10, the communication apparatus 20, and the image capture apparatus 30 forming the system according to the present embodiment will be described next with reference to FIGS. 2 to 4.

The control processing of the audio recording apparatus 10 will be described first.

FIG. 2 is a flowchart illustrating the control processing of the audio recording apparatus 10 according to the present embodiment.

The processing shown in FIG. 2 is started upon power-on of the audio recording apparatus 10, and is implemented when the audio recording control unit 11 controls each component of the audio recording apparatus 10 by loading the program stored in the nonvolatile memory into the work memory and executing the program.

In step S201, the audio recording control unit 11 executes initialization processing. In the initialization processing, the program read out from the nonvolatile memory, the constants and variables for executing the program, and the like are loaded into the work memory. The audio recording control unit 11 executes activation processing of performing a preparation operation by supplying power to each component of the audio recording apparatus 10.

The wireless LAN control unit 18 sets connection information such as a MAC address, an SSID, a data channel, and a transfer rate for performing wireless LAN connection to the communication apparatus 20 that forms the access point of the wireless LAN. By setting the connection information, the audio recording apparatus 10 performs wireless LAN connection processing to the communication apparatus 20 when detecting the access point formed by the communication apparatus 20.

In step S202, the audio recording control unit 11 confirms a wireless LAN connection state with the slave communication unit 17, and determines whether wireless LAN connection has been established. The audio recording control unit 11 continues the processing until it is determined that wireless LAN connection to the communication apparatus 20 has been established. In a case where it is determined that the wireless LAN connection has been established, the audio recording control unit 11 advances the process to step S203.

In step S203, the audio recording control unit 11 receives, by the wireless LAN control unit 18, time information from the image capture apparatus 30 via the communication apparatus 20. The time information is set in the image capture apparatus 30 connected to the communication apparatus 20. The wireless LAN control unit 18 outputs, to the time measurement unit 15, the time information of the image capture apparatus 30 received from the communication apparatus 20, and the time measurement unit 15 sets the time information of the image capture apparatus 30 as the reference time of the audio recording apparatus 10.

In step S204, the audio recording control unit 11 sends a time measurement start instruction to the time measurement unit 15. The time measurement unit 15 measures the time from the reference time set in step S203 in accordance with the time measurement start instruction of the audio recording control unit 11, and updates the time information in real time.

In step S205, the audio recording control unit 11 assigns an audio channel for identifying the audio recording apparatus 10 as the generation source of the audio file. As a method of assigning the audio channel, a method of assigning information unique to the audio recording apparatus 10 or an assignment method by wireless LAN connection is used. The assignment method by wireless LAN connection is, for example, a method of setting audio channel numbers in the order of pieces of equipment connected by the wireless LAN. The present embodiment shows an example in which the audio recording apparatus 10 forms a single slave, but a plurality of audio recording apparatuses can be connected, as slaves, to the communication apparatus 20 as the master. In a case where the plurality of audio recording apparatuses are connected to the communication apparatus 20 by the wireless LAN, an audio channel number is assigned to each of the plurality of audio recording apparatuses to identify each audio recording apparatus. As a method of assigning an audio channel number in a case where the plurality of audio recording apparatuses are connected by the wireless LAN, for example, CH1 is assigned to the first audio recording apparatus that is connected by the wireless LAN, and CH2 is assigned to the second audio recording apparatus that is connected by the wireless LAN.

In step S206, the audio recording control unit 11 sends an audio processing setting instruction to the audio processing unit 13. The audio processing setting includes adjustment of an audio level, the frequency characteristic of an equalizer, and a filter setting for a countermeasure against wind noise. The audio processing setting can be performed by changing the register value of the audio processing unit 13.

In step S207, the audio recording control unit 11 sends an audio data transmission instruction to the wireless LAN control unit 18. Upon receiving the audio data transmission instruction, the wireless LAN control unit 18 transmits the audio data generated by the audio processing unit 13 to the image capture apparatus 30 via the communication apparatus 20.

In step S208, the audio recording control unit 11 continues the processing until it is determined that the image capture apparatus 30 has started moving image recording. In a case where it is determined that the image capture apparatus 30 has started moving image recording, the audio recording control unit 11 advances the process to step S209. In a case where moving image recording start information is received from the image capture apparatus 30 via the communication apparatus 20, the audio recording control unit 11 determines that the image capture apparatus 30 has started moving image recording. When the image capture apparatus 30 starts moving image recording, the moving image recording start information is transmitted to the audio recording apparatus 10 via the communication apparatus 20. The audio recording apparatus 10 receives, by the wireless LAN control unit 18, the moving image recording start information from the communication apparatus 20.

In step S209, the audio recording control unit 11 receives the file name of the moving image file recorded by the image capture apparatus 30 from the image capture apparatus 30 via the communication apparatus 20.

In step S210, the audio recording control unit 11 determines whether the recording medium is connected to the recording medium IF 16. In a case where the recording medium IF 16 detects a connection signal, the audio recording control unit 11 determines that the recording medium is connected to the recording medium IF 16. In a case where it is determined that the recording medium is connected to the recording medium IF 16, the audio recording control unit 11 advances the process to step S211. In a case where it is determined that the recording medium is not connected to the recording medium IF 16, the audio recording control unit 11 advances the process to step S214.

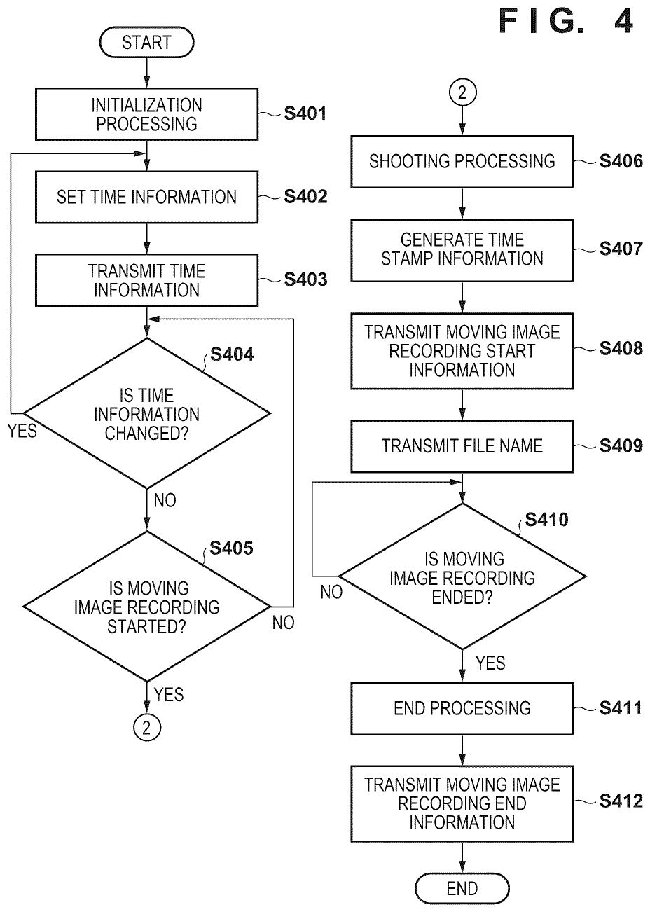

In step S211, the audio recording control unit 11 generates time stamp information synchronized with the moving image recording start timing in the image capture apparatus 30 based on the reference time set in step S203, the time when measurement is started in step S204, and the moving image recording start information received from the image capture apparatus 30 in step S208. Thus, time stamp information generated in step S407 of FIG. 4 to be described later and added to the moving image file generated by the image capture apparatus 30 and time stamp information added to the audio file generated by the audio recording apparatus 10 are common. Therefore, the moving image file generated by the image capture apparatus 30 can be associated with the audio file generated by the audio recording apparatus 10.

In step S212, the audio recording control unit 11 sets the file name of the audio file based on the file name received in step S209. For example, in a case where the file name of the moving image file is IMG0001, the file name of the audio file is set to AUDIO0001 obtained by setting the same numerical value as the numerical value of the file name of the moving image file. In this case, the time stamp information generated in step S211 or the audio channel number set in step S205 may be used as a part of the file name.

In step S213, the audio recording control unit 11 generates an audio file of the file name set in step S212 from the audio data generated by the audio processing unit 13 in step S207. The file generation unit 14 generates an audio file from the audio data generated by the audio processing unit 13, and adds, as metadata, the time stamp information generated in step S211 to the audio file. The file generation unit 14 writes the audio file in the recording medium via the recording medium IF 16.

In step S214, the audio recording control unit 11 continues the audio recording processing until it is determined that the image capture apparatus 30 has ended moving image recording. In a case where it is determined that the image capture apparatus 30 has ended moving image recording, the audio recording control unit 11 advances the process to step S215. In a case where moving image recording end information is received from the image capture apparatus 30 via the communication apparatus 20, the audio recording control unit 11 determines that the image capture apparatus 30 has ended moving image recording. When the image capture apparatus 30 ends moving image recording, the moving image recording end information is transmitted to the audio recording apparatus 10 via the communication apparatus 20. The audio recording apparatus 10 receives, by the wireless LAN control unit 18, the moving image recording end information from the communication apparatus 20.

In step S215, the audio recording control unit 11 sends an audio recording processing end instruction to the file generation unit 14. Upon receiving the audio recording processing end instruction from the audio recording control unit 11, the file generation unit 14 ends the processing of generating an audio file and recording it in the recording medium. After the end of the audio recording processing, the user can read out the audio file from the recording medium by a personal computer (PC) or the like, and reproduce the audio file.

With the above-described processing, the audio recording apparatus 10 can generate, via the communication apparatus 20 connected by the wireless LAN, an audio file with time stamp information common to the moving image file generated by the image capture apparatus 30. Therefore, the moving image file generated by the image capture apparatus 30 can be associated with the audio file generated by the audio recording apparatus 10.

The control processing of the communication apparatus 20 will be described next.

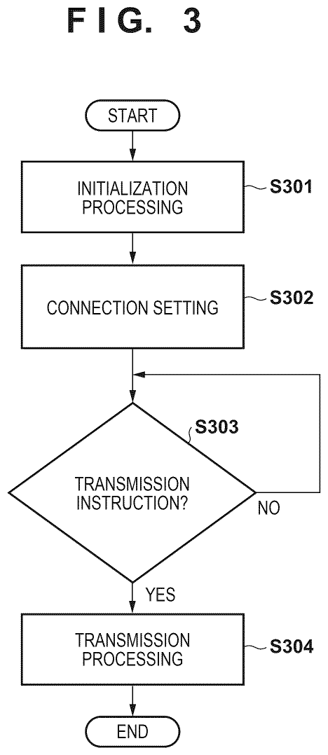

FIG. 3 is a flowchart illustrating the control processing of the communication apparatus 20 according to the present embodiment.

The processing shown in FIG. 3 is started upon power-on of the communication apparatus 20, and is implemented when the communication control unit 21 controls each component of the communication apparatus 20 by loading the program stored in the nonvolatile memory into the work memory and executing the program.

In step S301, the communication control unit 21 executes initialization processing. In the initialization processing, the program read out from the nonvolatile memory, the constants and variables for executing the program, and the like are loaded into the work memory. The communication control unit 21 executes activation processing of performing a preparation operation by supplying power to each component of the communication apparatus 20.

In step S302, the communication control unit 21 sets wireless LAN connection information of the master communication unit 22. The wireless LAN control unit 23 sets connection information such as a MAC address, an SSID, a data channel, and a transfer rate for performing wireless LAN connection to the audio recording apparatus 10. By setting the connection information, the audio recording apparatus 10 performs wireless LAN connection processing to the communication apparatus 20 when detecting the access point formed by the communication apparatus 20.

In step S303, the communication control unit 21 continues the processing until it is determined that an instruction to transmit information to the audio recording apparatus 10 is received from the camera control unit 31. In a case where it is determined that an instruction to transmit information to the audio recording apparatus 10 is received, the communication control unit 21 advances the process to step S304. The communication control unit 21 receives the transmission instruction from the camera control unit 31 by a communication method such as SPI or I2C.

In step S304, the communication control unit 21 transmits the information from the master communication unit 22 to the slave communication unit 17 of the audio recording apparatus 10 based on the transmission instruction received from the camera control unit 31 in step S303. The information transmitted from the image capture apparatus 30 to the audio recording apparatus 10 includes, for example, at least one of the time information in step S203 of FIG. 4, the moving image recording start information in step S208, the file name of the moving image file in step S209, and the moving image recording end information in step S214.

With the above-described processing, the communication apparatus 20 can transmit the time information and the moving image recording start information to the audio recording apparatus 10 in accordance with the transmission instruction of the image capture apparatus 30, and the audio recording apparatus 10 can generate, based on the information received from the image capture apparatus 30 via the communication apparatus 20, an audio file with time stamp information common to the moving image file generated by the image capture apparatus 30. Therefore, the moving image file generated by the image capture apparatus 30 can be associated with the audio file generated by the audio recording apparatus 10.

The control processing of the image capture apparatus 30 will be described next.

FIG. 4 is a flowchart illustrating the control processing of the image capture apparatus 30 according to the present embodiment.

The processing shown in FIG. 4 is started upon power-on of the image capture apparatus 30, and is implemented when the camera control unit 31 controls each component of the image capture apparatus 30 by loading the program stored in the nonvolatile memory into the work memory and executing the program.

In step S401, the camera control unit 31 executes initialization processing. In the initialization processing, the program read out from the nonvolatile memory, the constants and variables for executing the program, and the like are loaded into the work memory. The camera control unit 31 executes activation processing of performing a preparation operation by supplying power to each component of the image capture apparatus 30.

After the end of the activation processing in step S401, the camera control unit 31 displays, in step S402, on the display unit 34, a time setting screen for prompting the user to perform time setting. The user inputs time information to the time setting screen by operating the operation unit 33. The camera control unit 31 outputs, to the time measurement unit 41, the time information input to the time setting screen. The time measurement unit 41 sets, as the current time information, the time information input to the time setting screen, and measures the time by using the set time information as the reference time.

In step S403, the camera control unit 31 instructs the communication control unit 21 of the communication apparatus 20 to transmit the time information set in step S402 to the audio recording apparatus 10. Upon receiving the transmission instruction of the time information from the camera control unit 31, the communication control unit 21 of the communication apparatus 20 transmits the time information to the audio recording apparatus 10 via the master communication unit 22 of the communication apparatus 20.

In step S404, the camera control unit 31 determines whether the time information set in step S402 has been changed by the user operating the operation unit 33. In a case where it is determined that the time information has been changed, the camera control unit 31 returns the process to step S402. In a case where it is determined that the time information has not been changed, the camera control unit 31 advances the process to step S405.

In step S405, the camera control unit 31 determines whether a moving image recording start has been instructed by the user operating the operation unit 33. In a case where it is determined that a moving image recording start has been instructed, the camera control unit 31 advances the process to step S406. In a case where it is determined that no moving image recording start has been instructed, the camera control unit 31 returns the process to step S404.

In step S406, the camera control unit 31 instructs the shooting control unit 36 to start image capture processing. When the shooting control unit 36 receives the start instruction of the image capture processing from the camera control unit 31, the image processing unit 37 generates moving image data based on image data captured by the imaging unit 32, and the file generation unit 39 generates a moving image file from the moving image data generated by the image processing unit 37.

In step S407, the camera control unit 31 causes the file generation unit 39 to generate time stamp information synchronized with the moving image recording start timing based on the time measured by the time measurement unit 41 in step S402. Then, the camera control unit 31 adds, as metadata, the time stamp information to the moving image file generated in step S406. The file generation unit 39 writes the moving image file added with the time stamp information in the recording medium via the recording medium IF 35.

The file name of the moving image file is generated based on a predetermined rule. For example, in a case where the file name recorded in the recording medium is IMG0001, the file name of the moving image file recorded next in the recording medium is IMG0002 obtained by incrementing the numerical value of the file name of the recorded moving image file. The thus generated moving image file is recorded in the recording medium via the recording medium IF 35.

In step S408, the camera control unit 31 instructs the communication control unit 21 of the communication apparatus 20 to transmit, to the audio recording apparatus 10, the moving image recording start information based on the moving image recording start instruction received in step S405. Upon receiving the transmission instruction of the moving image recording start information from the camera control unit 31, the communication control unit 21 of the communication apparatus 20 transmits the moving image recording start information to the audio recording apparatus 10 via the master communication unit 22 of the communication apparatus 20. Thus, the time stamp information generated in step S211 of FIG. 2 described above and added to the audio file generated by the audio recording apparatus 10 in step S213 and time stamp information added to the moving image file generated by the image capture apparatus 30 are common. Therefore, the moving image file generated by the image capture apparatus 30 can be associated with the audio file generated by the audio recording apparatus 10.

In step S409, the camera control unit 31 instructs the communication control unit 21 of the communication apparatus 20 to transmit the file name of the moving image file generated in step S406 to the audio recording apparatus 10. Upon receiving the transmission instruction of the file name of the moving image file from the camera control unit 31, the communication control unit 21 of the communication apparatus 20 transmits the file name of the moving image file to the audio recording apparatus 10 via the master communication unit 22 of the communication apparatus 20.

In step S410, the camera control unit 31 continues the processing until it is determined that a moving image recording end has been instructed by the user operating the operation unit 33. In a case where it is determined that a moving image recording end has been instructed, the camera control unit 31 advances the process to step S411.

In step S411, the camera control unit 31 sends an end instruction of shooting processing to the shooting control unit 36. Upon receiving the end instruction of the shooting processing from the camera control unit 31, the shooting control unit 36 ends the processing of generating the moving image file and recording it in the recording medium. After the end of the shooting processing, the user can read out the moving image file from the recording medium by a personal computer (PC) or the like, and reproduce the moving image file.

In step S412, the camera control unit 31 instructs the communication control unit 21 of the communication apparatus 20 to transmit, to the audio recording apparatus 10, the moving image recording end information based on the moving image recording end instruction received in step S410. Upon receiving the transmission instruction of the moving image recording end information from the camera control unit 31, the communication control unit 21 of the communication apparatus 20 transmits the moving image recording end information to the audio recording apparatus 10 via the master communication unit 22 of the communication apparatus 20.

With the above-described processing, the image capture apparatus 30 can transmit, via the communication apparatus 20, the time stamp information and the file name of the moving image file to the audio recording apparatus 10 connected by the wireless LAN, and the audio recording apparatus 10 can generate an audio file with time stamp information common to the moving image file generated by the image capture apparatus 30. Therefore, the moving image file generated by the image capture apparatus 30 can be associated with the audio file generated by the audio recording apparatus 10.

According to the present disclosure, it is possible to associate an audio file and an image file recorded in different apparatuses with each other.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. A wireless microphone capable of communicating with an image capture apparatus, comprising:
a generation unit configured to generate audio data;
a transmission unit configured to transmit, as audio data for a moving image file generated by the image capture apparatus, the audio data to the image capture apparatus;
a recording unit configured to record the audio data as an audio file; and
a control unit configured to receive information including time information from the image capture apparatus, and add, to the audio file, time stamp information generated based on the time information received from the image capture apparatus,
wherein transmission of the audio data to the image capture apparatus by the transmission unit and recording of the audio data by the recording unit are executed simultaneously.

2. The wireless microphone according to claim 1, wherein the transmission unit transmits the audio data to the image capture apparatus by transmitting the audio data to a communication accessory attached to the image capture apparatus.

3. The wireless microphone according to claim 1, wherein the audio data includes no image data.

4. The wireless microphone according to claim 1, wherein the wireless microphone includes no imaging unit.

5. The wireless microphone according to claim 1, further comprising:
a measurement unit configured to measure a time by using, as a reference time, the time information received from the image capture apparatus,
wherein the control unit generates, based on the time measured by the measurement unit, time stamp information synchronized with a timing at which the image capture apparatus starts moving image recording.

6. The wireless microphone according to claim 1, wherein the control unit sets a file name of the audio file based on a file name received from the image capture apparatus.

7. The wireless microphone according to claim 6, wherein the file name received from the image capture apparatus is a file name of a moving image file recorded by the image capture apparatus.

8. The wireless microphone according to claim 6, wherein the file name is set based on one of information unique to the wireless microphone and an order of connection of the wireless microphone.

9. The wireless microphone according to claim 5, wherein
in a case where the time information of the image capture apparatus is changed, the control unit receives the changed time information from the image capture apparatus, and
the measurement unit measures the time by using, as the reference time, the changed time information received from the image capture apparatus.

10. The wireless microphone according to claim 1, wherein
the wireless microphone communicates with the image capture apparatus by a wireless LAN (Local Area Network), and
the wireless microphone operates as a slave of the wireless LAN that is connected to a communication apparatus operating as a master of the wireless LAN.

11. The wireless microphone according to claim 10, wherein
the control unit receives the time information set in the image capture apparatus, and moving image recording start information and moving image recording end information in the image capture apparatus, which are transmitted from the communication apparatus based on a transmission instruction of the image capture apparatus, and
the time stamp information is generated based on the time information set in the image capture apparatus and the moving image recording start information in the image capture apparatus.

12. A wireless microphone capable of communicating with an image capture apparatus, comprising:
a connection unit configured to detachably connect to a memory card;
a generation unit configured to generate audio data;
a transmission unit configured to transmit, as audio data for a moving image file generated by the image capture apparatus, the audio data to the image capture apparatus;
a recording unit configured to record the audio data as an audio file in the memory card; and
a control unit configured to receive information from the image capture apparatus, and add, to the audio file, additional information generated based on the information received from the image capture apparatus.

13. A control method for a wireless microphone capable of communicating with an image capture apparatus, comprising:
generating audio data;
transmitting, as audio data for a moving image file generated by the image capture apparatus, the audio data to the image capture apparatus;
recording the audio data as an audio file; and
receiving information including time information from the image capture apparatus, and adding, to the audio file, time stamp information generated based on the time information received from the image capture apparatus,
wherein transmission of the audio data to the image capture apparatus and recording of the audio data are executed simultaneously.

14. A control method for a wireless microphone capable of communicating with an image capture apparatus, comprising:
detachably connecting to a memory card;
generating audio data;
transmitting, as audio data for a moving image file generated by the image capture apparatus, the audio data to the image capture apparatus;
recording the audio data as an audio file in the memory card; and
receiving information from the image capture apparatus, and adding, to the audio file, additional information generated based on the information received from the image capture apparatus.

15. A non-transitory computer-readable storage medium storing a program for causing a computer to function as a wireless microphone capable of communicating with an image capture apparatus, comprising:
a generation unit configured to generate audio data;
a transmission unit configured to transmit, as audio data for a moving image file generated by the image capture apparatus, the audio data to the image capture apparatus;
a recording unit configured to record the audio data as an audio file; and
a control unit configured to receive information including time information from the image capture apparatus, and add, to the audio file, time stamp information generated based on the time information received from the image capture apparatus,
wherein transmission of the audio data to the image capture apparatus by the transmission unit and recording of the audio data by the recording unit are executed simultaneously.

16. A non-transitory computer-readable storage medium storing a program for causing a computer to function as a wireless microphone capable of communicating with an image capture apparatus, comprising:
a connection unit configured to detachably connect to a memory card;
a generation unit configured to generate audio data;
a transmission unit configured to transmit, as audio data for a moving image file generated by the image capture apparatus, the audio data to the image capture apparatus;
a recording unit configured to record the audio data as an audio file in the memory card; and
a control unit configured to receive information from the image capture apparatus, and add, to the audio file, additional information generated based on the information received from the image capture apparatus.
